(19) United States
(12) Patent Application Publication
(10) Pub. No.: US 2014/0158609 A1
(43) Pub. Date: Jun. 12, 2014

(54) Sand Screen Filter for an Oil or Gas Well

(71) Applicant: POROUS METAL FILTER, Spring, TX (US)

(72) Inventors: Robert J. Provo, Spring, TX (US); Patrick W. McGrenera, The Woodlands, TX (US); Ruediger Tueshaus, Dorsten (DE); Rick T. Kenney, Longwood, FL (US)

(73) Assignee: Porous Metal Filter, Spring, TX (US)

(21) Appl. No.: 13/708,124

(22) Filed: Dec. 7, 2012

(51) Int. Cl. B01D 29/19; B01D 29/11

(52) U.S. Cl. CPC B01D 29/19; B01D 29/111
USPC 210/489; 210/497.01; 29/428

(57) ABSTRACT

A filter screen is formed by a first sheet metal frame having one or more cutout sections. A first layer of screening is placed on top of the frame but does not extend to the edges of the frame. An optional second layer of screening may be placed over the top of the first layer such that it extends beyond the perimeter of the first layer but not to the perimeter of the frame. The assembly is then fusion bonded together and rolled into a tubular configuration. Abutting edges of the frame are welded together to form a rigid filter screen.

### BACKGROUND OF INVENTION

1. Field of the Invention

This invention is for a screen filter which commonly may be used for example, in the production phase of an oil or gas well.

2. Description of Related Art

Known screen filters as exemplified by U.S. Pat. No. 6,415,509 consists of a perforated plate to which is bonded one or more filter screens and/or drainage layers. In constructing the filters, the perforated plate and the wire mesh sheet stack 40a which may include wire mesh layer 48, 50 and 52 are cut to the same dimensions. The wire mesh sheet stack is then bonded to the inner side of the perforated plate. The individual sheets 48, 50 and 52 can be bonded together at the same time or bonded together beforehand. A preferred method of bonding is diffusion bonding.

The assembly is then trimmed to a specific dimension and rolled into a tubular configuration. The abutting edges are joined by a seam weld as shown in 56 in FIG. 3.

This type of construction has several major drawbacks. First since the sheets of filter medium are all the same size, by-pass of the liquid to be filtered may occur at the edges of the sheets, which results in the sand particles or other particulate material to be transported to the surface.

Secondly, when the sheets are welded along seam 56, the heat of the welding process can weaken the screens along the edges of the seam weld so as to compromise the bonding of the screens to the perforated plate.

### BRIEF SUMMARY OF THE INVENTION

According to the present invention, a screen filter is formed by providing a flat sheet of thin material such as stainless steel having one or more cut out sections. A first screen of relatively coarse screen size is positioned on top of the flat sheet but does not extend to the periphery of the sheet. This first screen primarily is for forming flow passages. A second screen of relatively fine screen size to form a screening layer is placed on top of the first screen layer and extends beyond the periphery of the first screen layer but stops short of the outer periphery of the flat sheet in a manner disclosed herein. The layers and the flat sheet material are then diffusion bonded together throughout. Finally, the resultant assembly is rolled into the shape of a tubular and the abutting edges are welded together to form the final screen filter. The screen filter may then be placed and secured over a perforated base pipe for use in an oil or gas well, or in any other environment where filtering is desired. As an alternative the first layer may have a relatively small mesh size while the second layer may have a relatively coarse screen size. The screens may be made of woven and non-woven wire cloth, sintered material, fibers or any metallic porous material.

According to another embodiment of the invention, the screen filter may include a frame formed as thin layer of flat sheet material having one or more cut out sections and having a single screen on top that does not extend to the outer edge of the frame.

Furthermore, the frame and screen assembly can have a relatively long dimension with a smaller width so that it may be rolled into a helical configuration thus forming a tubular as explained below.

The above construction eliminates the possibility of fluid by-pass and also reduces the adverse effect on the screen bonds caused by the longitudinal seam weld.

### BRIEF DESCRIPTION OF THE SEVERAL VIEWS OF THE DRAWING(S)

FIG. 1 is a top view of an embodiment of a screen filter according to the invention prior to rolling the sheets into a tubular configuration.

FIG. 2 is a cross-section view taken along line 2-2 of FIG. 1.

FIG. 3 is a perspective view of a finished filter.

FIG. 4 is a cross-sectional view of a second embodiment according to the invention.

FIG. 5 is a top view of a further embodiment of the invention.

FIG. 6 is a perspective view of a finished filter according to the embodiment of FIG. 5.

### DETAILED DESCRIPTION OF THE INVENTION

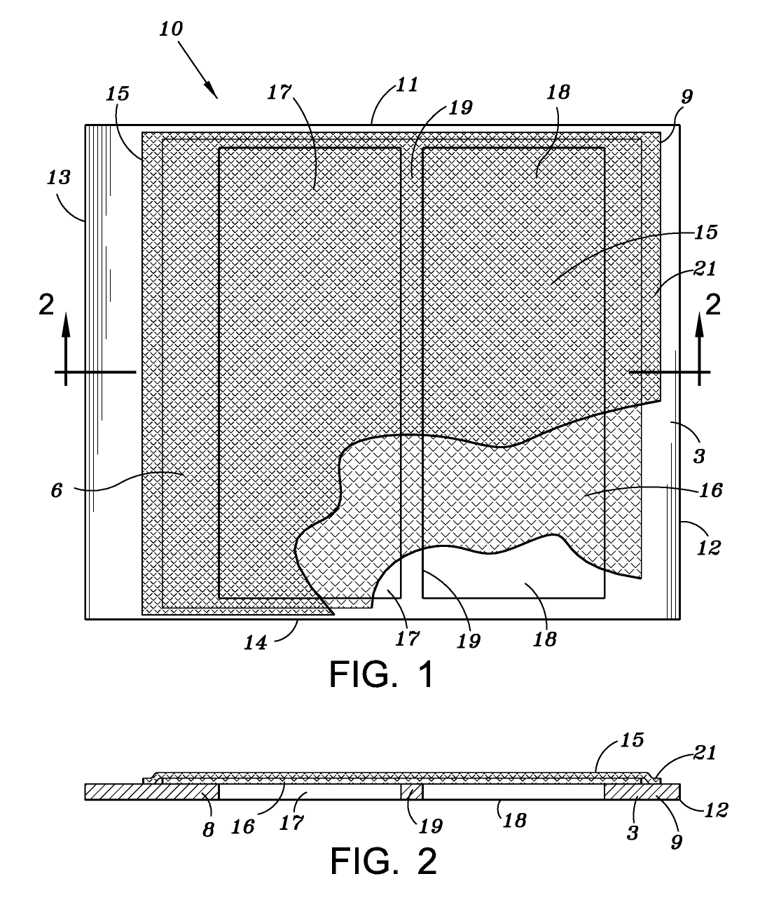

As shown in FIG. 1, the filter 10 of the present invention includes a flat sheet of sheet metal 3 for example 316L stainless steel cut to any desired size. The sheet metal may be of any desired thickness for example 0.010 to 5 inches.

One or more cutout sections 17 and 18 are formed in the sheet which creates a center strip 19 which extends between the top and bottom edges 11 and 14 of the sheet. Openings 17 and 18 may have square corners as shown or the corners may be rounded for improved structural integrity.

The thus formed sheet serves as a frame for supporting the woven wire filter screens as discussed below.

As shown in FIG. 2 a first screen is placed on top of the frame 3. First screen is sized so as to not extent to either the top or bottom edges 11 and 14 or to the side edges 12 and 13 of the frame. First screen layer 16 may be a woven or non-woven wire metal cloth having a mesh size for example 2-2000 microns but in any event is selected to have larger openings than that of layer 15. Layer 16 serves as a first filter stage and also provides flow passages to allow fluid to pass from the formation of the well through the next filter layer.

A second screen 15 having an opening size smaller than that of screen 16 is placed over the first layer and is sized so as to extend beyond the four sides of screen 16 but short of the outer periphery of frame 3.

Thus, first screen 16 is sandwiched between screen 15 and the frame 3. Second screen 15 serves primarily as a filtering layer and may have openings in the range of 2-800 microns. This assembly is then heated to such a temperature and pressure is applied such that all the contracting metal surfaces are diffusion bonded to each other. As is understood in the industry, the assembly is heated to a temperature below the melting point of the metal and pressure is applied so as to form a diffusion bond. A diffusion bond is formed at all points where metal is in contact with metal.

Screens 15 and 16 could be bonded to each other and then bonded to frame 3 or all three components can be simultaneously bonded together.

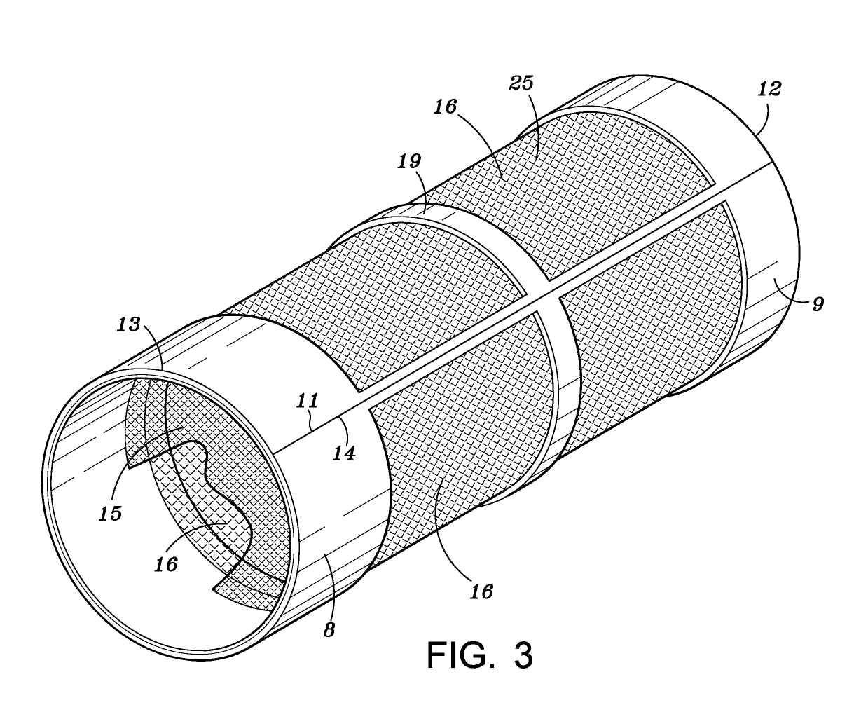

After the screens 15 and 16 and frame 3 have been diffusion bonded together, the resulting structure can be deformed to a cylindrical structure as shown in FIG. 3 wherein top edge 11 and bottom edge 14 are brought into an abutting position. Sides 8 and 9 (FIG. 2) form outer cylindrical band sections and strip 19 forms an intermediate band section. Screens 16 and 15 are positioned within the frame formed by the sheet metal. Abutting edges 11 and 14 can now be secured together in any known manner including fusion welding, a cold weld, epoxy, or any known mechanical method.

When used in a well environment, the filter as shown in FIG. 3 may be placed over and secured to an apertured tubular base pipe to filter the produced oil or gas as it enters the base pipe.

Although first screen 16 has been illustrated as a single layer of woven or non-woven wire cloth, it may consist of one or more layers of woven or non-woven cloth wire. Such is also the case for the second screen 15.

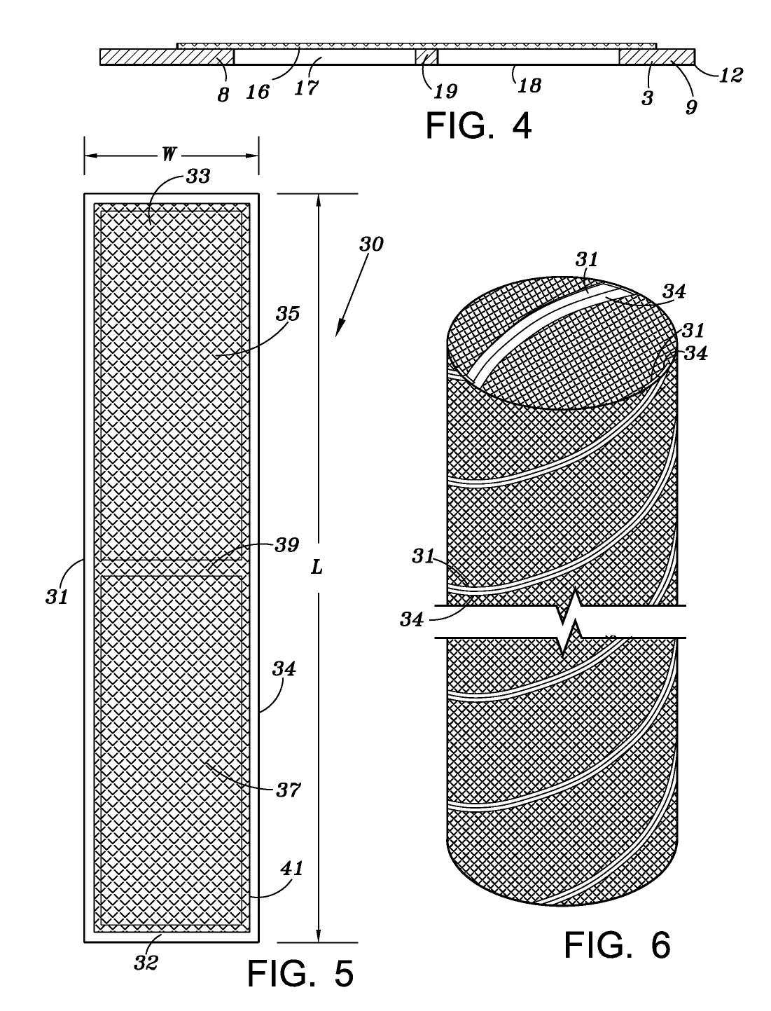

FIG. 4 illustrates a second embodiment of the invention. In this embodiment, a single screen 16 of any desired mesh size is positioned over frame 3 in the manner shown in FIG. 1 such that its four sides do not extend to the outer edges of frame 3. Screen 16 is then diffusion bonded to frame 3. The resulting assembly can then be rolled into a cylindrical shape as shown in FIG. 3 and edges 11 and 14 are welded together for example by fusion welding.

FIG. 5 depicts an additional embodiment of the invention wherein frame 41 has a relatively long dimension L and a relatively narrow dimension W. The frame may include sides 31, 34 and sides 33, 32. A cross members 39 extends between sides 31 and 34. One or more cutouts 35, 37 are formed in the frame. Frame 41 may be used with two screens as shown in FIG. 1 or with a single screen as shown in FIG. 4. Once the screen or screens are positioned and bonded to the frame, the assembly may be helically wound into a tubular configuration as shown in FIG. 6 wherein abutting sides 31 and 34 are welded together by any known technique. In the embodiment of FIG. 6, the screen or screens may be formed by screens having a different screen size along the length thereby providing screening zones of different screen sizes.

Other embodiments of the invention will be apparent to those with ordinary skill in the art. For example, a third screen similar to screen 16 and a fourth screen similar to screen 15 could be positioned on the bottom side of frame 3 of the embodiment shown FIGS. 1 and 2 so that the frame lies between two layers of screens. Also, the assembly of FIG. 2 can be rolled into the configuration of FIG. 3 with the screens 15 and 16 positioned within the tubular formed by the frame or on outside surface of the tubular.

Furthermore, an additional frame could be placed on top of screens 16 and 15 of the embodiment of FIGS. 1 and 2 so that the screens or screen are sandwiched between two frame members. In these variations, the screens and frames could be bonded together by fusion bonding in one step.

Although the present invention has been described with respect to specific details, it is not intended that such details should be regarded as limitations on the scope of the invention, except to the extent that they are included in the accompanying claims.

I claim:

1. A filter screen assembly comprising:
a frame formed of sheet material having one or more cutout portions, said frame having top, bottom and side edges,
a first screen positioned on the frame and having top and bottom edges of a given size so as to not extend to the top and bottom edges of the frame,
the frame and screen being bonded to each other by a diffusion bond,
the frame and screen being rolled into a cylindrical, conical or other tubular configuration wherein the top and bottom edges of the frame are in an abutting relationship, and
means for securing the abutting top and bottom edges of the frame to each other to form a rigid filter screen assembly.

2. A filter screen assembly as claimed in claim 1 further comprising a second screen positioned on top of the first screen and having top and bottom edges that extend beyond the top and bottom edges of the first screen but not to the top or bottom edges of the frame.

3. A filter screen assembly according to claim 2 wherein the first screen has side edges that do not extend to the side edges of the frame and wherein the second screen has side edges that extend beyond the side edges of the first screen but do not extend to the side edges of the frame.

4. A filter screen assembly as claimed in claim 1 wherein the frame includes two or more cutouts to form a grid and at least one strip of metal between the cutouts that extends from the top to the bottom of the frame.

5. A filter screen assembly as claimed in claim 1 wherein the cutout has square corners.

6. A filter screen assembly as claimed in claim 1 wherein the cutout has rounded corners.

7. A method of fabricating a filter screen assembly comprising:
providing a frame of sheet metal material having one or more cutouts,
placing a screen on top of the sheet metal frame such that a top and bottom edge of the screen does not extend to a top and bottom edge of the frame,
securing the frame and screen together by diffusion bonding,
rolling the frame and screen into a tubular configuration, such that the top and bottom edges of the frame are abutting each other, and
welding the abutting top and bottom edges of the frame together to form a rigid structure.

8. The method of claim 7 where the top and bottom edges of the frame are welded together by a fusion weld.

9. A method of fabricating a filter screen assembly as claimed in claim 7 where the frame has two cutouts and a strip of sheet material extends from the top to the bottom of the frame between the two cutouts.
a filter screen according to claim 1 wherein the frame and the first filter are helically rolled into a tubular configuration.
a filter screen assembly according to claim 1 wherein the first screen includes a plurability of zones of different mesh sizes.

10. A method of fabricating a filter screen assembly as claimed in claim 7 including the step of placing a second screen on top of the first screen such that the second screen overlaps the first screen but does not extend to the top and bottom edge of the frame, and securing the second screen to the first screen and frame by diffusion bonding.

11. A filter screen assembly comprising:
a frame formed of sheet material having one or more cutout portions, said frame having top, bottom and sides edges;
a first screen positioned on the frame and having top and bottom edges of a given size so as to not extend to the top and bottom edges of the frame;
the frame and screen being bonded to each other by a diffusion bond;
the frame and screen being rolled into a tubular configuration wherein the side edges of the frame are in an abutting relationship; and
a weld extending along the abutting side edges of the frame to form a rigid filter screen assembly.

12. A filter screen assembly as claimed in claim 11 further comprising a second screen positioned on top of the first screen and having top and bottom edges that extend beyond the top and bottom edges of the first screen but not to the top or bottom edges of the frame.

13. A filter screen assembly according to claim 12 wherein the first screen has side edges that do not extend to the side edges of the frame and wherein the second screen has side edges that extend beyond the side edges of the first screen but do not extend to the side edges of the frame.

14. A filter screen assembly as claimed in claim 11 wherein the frame includes two cutouts and a strip of metal between the cutouts that extends between the sides of the frame.

15. A filter screen assembly as claimed in claim 1 wherein the means for securing the abutting top and bottom edges of the frame to each other comprises a weld.
